(19) United States
(12) Patent Application Publication
(10) Pub. No.: US 2015/0122794 A1
(43) Pub. Date: May 7, 2015

(54) TARGETED HEATING OF SUBSTRATE

(71) Applicants: Carl Bildstein, Lafayette, CO (US); Stuart Boland, Denver, CO (US); Scott Johnson, Erie, CO (US); Casey Walker, Boulder, CO (US)

(72) Inventors: Carl Bildstein, Lafayette, CO (US); Stuart Boland, Denver, CO (US); Scott Johnson, Erie, CO (US); Casey Walker, Boulder, CO (US)

(73) Assignee: Ricoh Company Ltd, Tokyo (JP)

(21) Appl. No.: 14/070,231

(22) Filed: Nov. 1, 2013

(51) Int. Cl. H05B 3/00

(52) U.S. Cl. CPC H05B 3/0095; H05B 3/0033
USPC 219/388

(57) ABSTRACT

Systems and methods are provided for applying targeted heat to a web of print media to improve the consistency of the web prior to printing. The system comprises a heater, a sensor, and a controller. The heater is able to apply targeted heat to a web of print media before the web travels through a continuous-forms printer. The sensor is able to measure a level of tension in at least one region of the web. The controller is able to direct the heater to apply a level of heat to the at least one region based on the level of tension.

### FIELD OF THE INVENTION

The invention relates to the field of continuous-forms printing systems.

### BACKGROUND

Entities with substantial printing demands typically use a production printer. A production printer is a high-speed printer used for volume printing (e.g., one hundred pages per minute or more). Production printers include continuous-forms printers that print on a web of print media stored on a large roll.

A production printer typically includes a localized print controller that controls the overall operation of the printing system, and a print engine (sometimes referred to as an “imaging engine” or a “marking engine”). The print engine includes one or more printhead assemblies, with each assembly including a printhead controller and a printhead (or array of printheads). An individual printhead includes multiple tiny nozzles that are operable to discharge ink as controlled by the printhead controller. A printhead array is formed from multiple printheads that are spaced in series across the width of the web of print media.

While the printer prints, the web is quickly passed underneath the nozzles, which discharge ink onto the web at intervals to form pixels. In order to ensure that the web is consistently positioned underneath the nozzles, steering systems can be used to align the web laterally with respect to its direction of travel. However, even when a steering system is in place, small fluctuations in the physical properties of the web (e.g., inconsistent edge length, lateral tension variation, bowing, etc.) can shift the web and drastically reduce print quality. For example, when multiple printheads are used by a printer to form a mixed color pixel, a small fluctuation in web position can cause one printhead to mark the correct physical location, while another printhead marks the wrong physical location. This distorts the final color of the pixel in the printed job.

### SUMMARY

Embodiments described herein apply targeted heat to a web of print media to improve the consistency of the web prior to printing. Some areas of a web may be stretched or otherwise distorted during manufacturing or transport of the web. These deformities are often associated with a low level of tension in the web compared with other, unaffected areas of the web. When printing, the contrast of tension levels in the plane of the web can cause unpredictable shifting of the web as it passes underneath the printhead nozzles, thereby reducing print quality. However, a controlled heat source can shrink the web and increase tension in localized areas. By identifying and correcting low tension areas in the web, the consistency of the web can be improved prior to being passed underneath the printhead nozzles for improved print quality.

One embodiment is a system that includes a heater, a sensor, and a controller. The heater is able to apply targeted heat to a web of print media before the web travels through a continuous-forms printer. The sensor is able to measure a level of tension in one or more regions of the web. The controller is able to direct the heater to apply a level of heat to the one or more regions based on the level of tension.

Another embodiment is a method. The method includes measuring a level of tension in a region of a web of print media for a continuous-forms printer. The method also includes directing a heater to apply a level of heat to the region based on the level of tension before the web travels through the continuous-forms printer. In one embodiment, the applied heat to the region is inversely proportional to the measured level of tension in the region.

Other exemplary embodiments (e.g., methods and computer-readable media relating to the foregoing embodiments) may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates an exemplary continuous-forms printing system.

FIG. 2 is a diagram illustrating exemplary problems resulting from non-uniform physical properties of a web.

FIG. 3 is a block diagram illustrating a printing system that corrects non-uniform physical properties of a web in an exemplary embodiment.

FIG. 4 is a flowchart illustrating a method for correcting non-uniform physical properties of a web in an exemplary embodiment.

FIG. 5 is a block diagram of a heat targeting system in an exemplary embodiment.

FIG. 6 is a block diagram of a top view a heat targeting system in another exemplary embodiment.

FIG. 7 is block diagram of a processing system operable to execute a computer readable medium embodying programmed instructions to perform desired functions in an exemplary embodiment.

### DETAILED DESCRIPTION

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

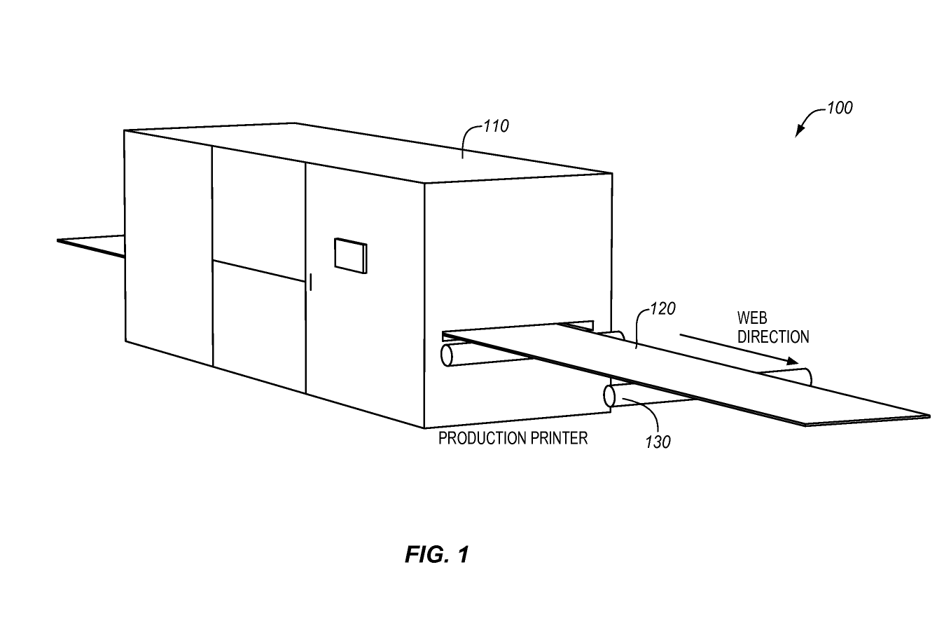

FIG. 1 illustrates an exemplary continuous-forms printing system 100. Printing system 100 includes production printer 110, which is operable to apply ink onto a web 120 of continuous-form print media (e.g., paper). As used herein, the word “ink” is used to refer to any suitable marking fluid (e.g., aqueous inks, oil-based paints, etc.). Printer 110 may comprise an inkjet printer that applies colored inks, such as Cyan (C), Magenta (M), Yellow (Y), and Key (K) black inks. One or more rollers 130 position and tension web 120 as it travels through printing system 100.

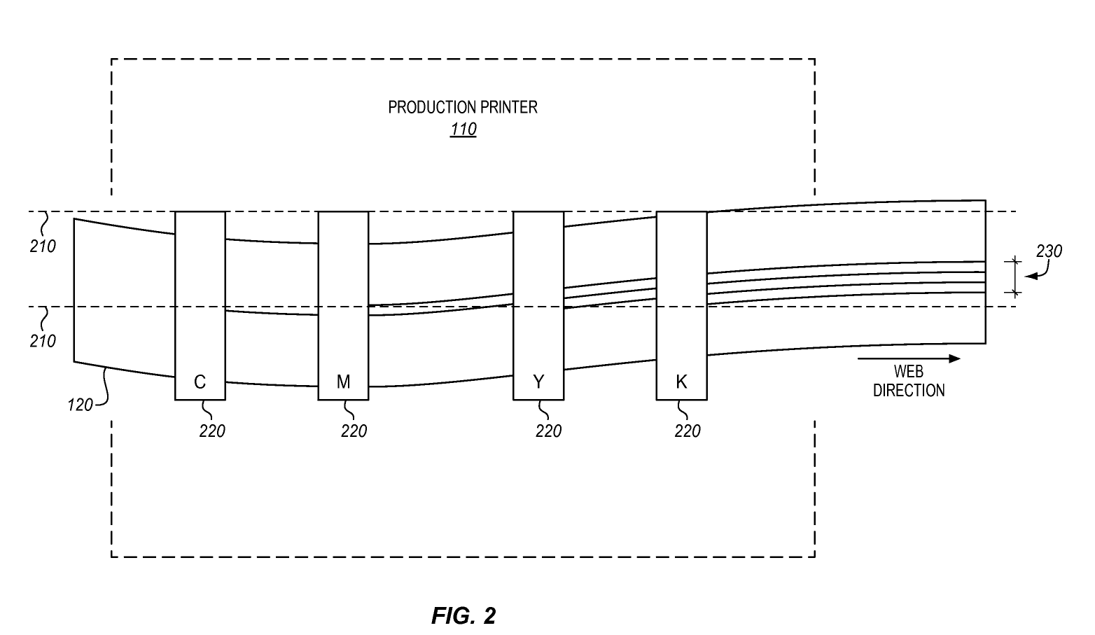

FIG. 2 is a diagram illustrating exemplary problems resulting from non-uniform physical properties of a web 120. For instance, varied tension across the plane of web can cause the web to drift laterally. As used herein, a lateral shift is a positional change that is within the plane of the web and orthogonal to the direction of travel of the web (i.e., orthogonal to the length of the web, and parallel to the width of the web). Lateral web oscillations can be particularly troublesome in a printing system that has a long printing area and/or multiple color planes.

In this case, each printhead 220 acts as a color plane for one of cyan, magenta, yellow, or key black. In FIG. 2, each printhead 220 is aligned in the same position relative to its peers, as indicated by reference lines 210. When the printheads 220 are aligned in this manner, they will all mark exactly the same lateral position with respect to each other. However, the inconsistent physical properties of the web 120 cause fluctuation in the position of the web 120 between printheads 220 as the web 120 passes through the production printer 110. When this occurs, ink is marked by each printhead 220 in a different lateral position on web 120, as shown by element 230. This color separation can lead to a reduction in print quality.

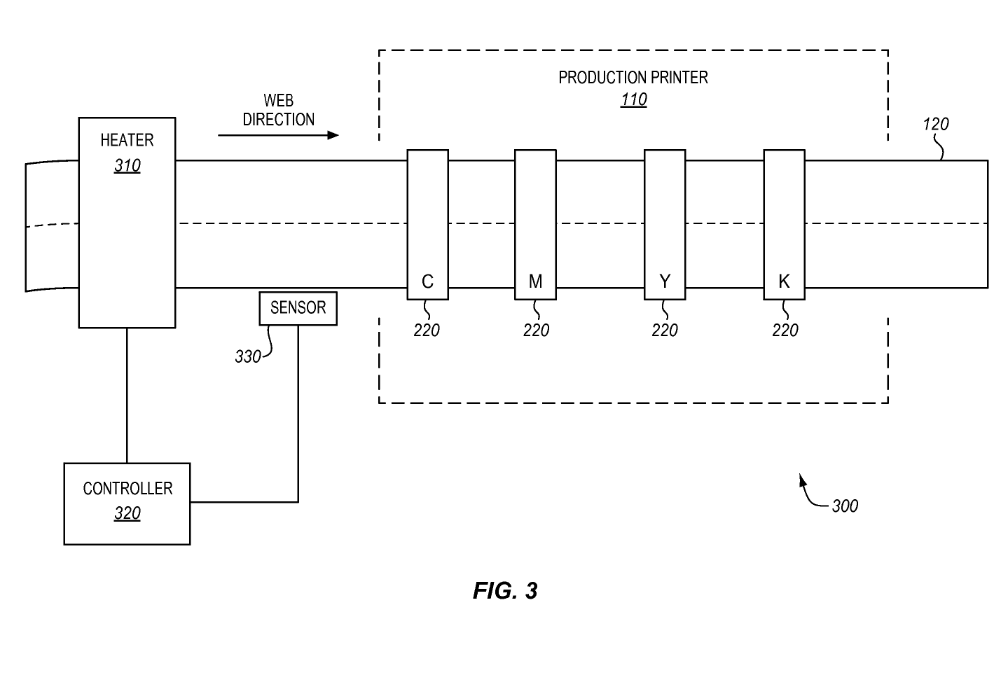

To address these problems associated with inconsistent web properties, FIG. 3 illustrates a printing system 300 that corrects non-uniform physical properties of a web 120 in an exemplary embodiment. Printing system 300 comprises any system, component, or device operable to mark a web 120 of print media. As can be seen in FIG. 3 and described in more detail below, printing system 300 has been enhanced with a heater 310, a controller 320, and a sensor 330 that collectively enable targeted heating of the web 120 such that inconsistent physical properties of the web 120 are corrected and/or improved prior to being marked by printheads 220 in the production printer 110.

The sensor 330 comprises any system, component, or device operable to detect a level of tension in one or more regions of the web 120. For example, the sensor 330 may comprise a laser, pneumatic, photoelectric, ultrasonic, infrared, optical, or any other suitable type of sensing device. In one embodiment, the sensor 330 comprises a physical pressure sensor that can detect an amount of force applied to it by web 120 during travel. Alternatively or additionally, the sensor 330 is operable to detect an amount of vertical displacement of the web 120 during travel.

The controller 320 comprises any system, component, or device operable to control a heat profile of the heater 310 based on tension information received from the sensor 330. The particular configuration of temperature levels at different locations defines the heat profile. For example, the controller 320 may direct the heater 310 to apply a higher level of heat in regions of the web 120 with lower tension to induce shrinkage and increase the tension in those areas such that the surface of the web 120 is improved prior to printing. Controller 320 can be implemented, for example, as custom circuitry, as a processor executing programmed instructions stored in an associated program memory, or some combination thereof.

The heater 310 comprises any system, component, or device operable to apply heat to the web 120. The heater 310 adjusts the level of heat and/or the location of heat based on the input received from controller 320. The heater 310 may comprise one or more radiant emitters (e.g., an array of heat lamps) that generate Infrared (IR) or Near IR (NIR) energy to radiantly heat the web 120. Alternatively or additionally, the heater 310 may comprise one or more conductive heated rollers than can vary the heat laterally across the web.

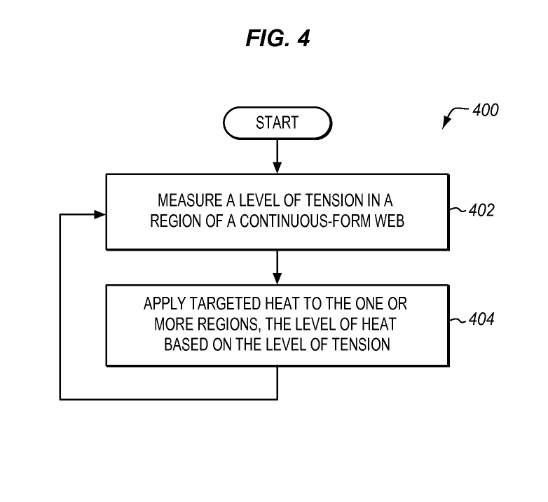

Illustrative details of the operation of printing system 300 will be discussed with regard to FIG. 4. FIG. 4 is a flowchart illustrating a method of correcting non-uniform physical properties of the web 120 in an exemplary embodiment. The steps of method 400 are described with reference to printing system 300 of FIG. 3, but those skilled in the art will appreciate that method 400 may be performed in other systems. The steps of the flowcharts described herein are not all inclusive and may include other steps not shown. The steps described herein may also be performed in an alternative order.

At step 402, one or more sensor(s) 330 measure a level of tension in one or more regions of the web 120. In one embodiment, the sensor 330 is located downstream from heater 310 and measures tension after targeted heat has been applied to the web 120 (e.g., a feedback system as shown in FIG. 3). Additionally or alternatively, one or more sensors may be located upstream as a feed forward system wherein tension is measured by the sensors prior to targeted heating of the web 120. The sensor 330 is configured to identify a non-conforming region (e.g., an area with below-average tension) and communicate the region location and tension information to the controller 320. In an alternative embodiment, regions of the web 120 are predefined (e.g., the width of the web 120 is divided into multiple regions) and tension information for each region is continually measured and communicated to the controller 320.

At step 404, the controller 320 directs the heater 310 to apply a level of heat to one or more regions of the web 120 based on tension information received from the sensor 330. The heater 310 applies targeted heat to one or more regions of the web 120 under the direction of the controller 320. For instance, the controller 320 may selectively control the on/off state and/or intensity level of one or more radiant heat lamps in an array of radiant heat lamps that span across a width of the web 120. In order to target heat to a particular region of the web 120, the controller 320 may power on or increase the intensity level of those lamps in the lamp array which have a location in the lamp array that corresponds with a low tension region of the web 120.

Steps 402 and 404 may be repeated such that the controller 320 continually and adaptively adjusts/readjusts the level of heat and/or the location of the heat to correct for non-uniformities of the web 120. When the web 120 is corrected or substantially corrected prior to being marked with ink, shifts of the web 120 during printing and/or color pixel misregistration can be reduced/eliminated for higher quality printing.

### Example

### Heat Targeting System

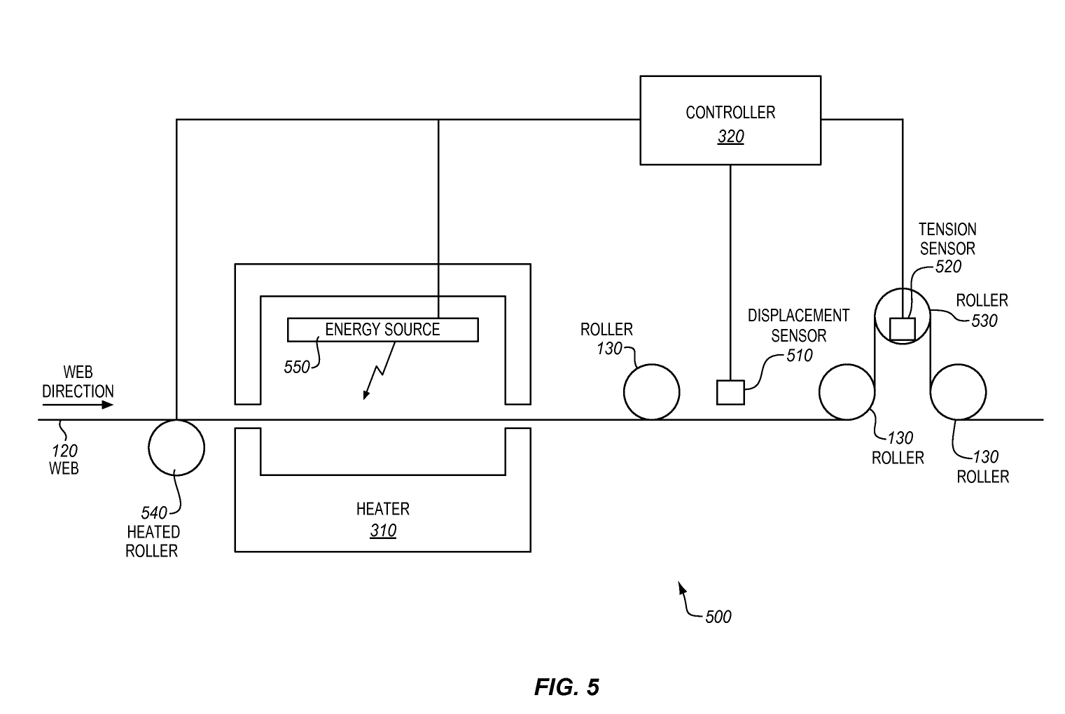

FIG. 5 is block diagram of a heat targeting system 500 in an exemplary embodiment. Heat targeting system 500 includes a heater 310 that receives a web 120 of continuous-form print media that is tensioned and/or driven by one or more rollers 130 through the heater 310 in the web direction indicated in FIG. 5. The heater 310 includes one or more energy source(s) 550 such as IR radiant lamps that can direct heat towards specific areas of the web 120 to smooth or shrink the web 120 in those areas.

Heat targeting system 500 includes a controller 320, displacement sensor 510, and/or tension sensor 520 that can operate together to identify uneven (i.e., low tension) regions of the web 120. A low tension region may be characterized by inconsistent edge length of the web 120 (i.e., bowing), vertical displacement of the web 120 from a horizontal plane formed by two rollers, changes in vertical or lateral forces in the web 120, or some combination of the above. In one embodiment, the tension measurement may be taken between parallel rollers 130 by one or more sensors disposed vertically above the web 120 (e.g., displacement sensor 510). Alternatively or additionally, one or more sensors may be positioned along one or both sides of the web 120. Sensors may also be integrated into other components of the system. For instance, tension sensor 520 is integrated as part of a roller 530 that is configured in such a way that a vertical force measurement can be taken at different points of the web 120 as it passes over the roller 530.

When the controller 320 receives input from the sensors regarding the tension, force, displacement, and/or edge length, it may calculate a level of heat to apply to each location based on various considerations. These considerations include, but are not limited to, the type of material of the web 120, the type of tension measurement (i.e., force measurement, edge length measurement, vertical displacement measurement, etc.), the speed at which the web 120 is traveling, the resolution of the associated printing system, the number and type of heat sources used, etc. Additionally, the controller 320 may interpolate a level of tension from a measurement of force or from an edge measurement of the web 120. In some embodiments, such as where a sensor is in a feed forward configuration, the controller 320 may implement a lag time of the applied heat based on the distance between the tension measurement and heat application and the speed of the web 120.

When information regarding the level of tension in a given area is received, the controller 320 may next determine whether to apply heat to the web 120. For instance, in one embodiment, the controller 320 may determine that the tension level, tension type, and/or tension location in the web 120 is unlikely to or does not reduce print quality. In such a case, the controller 320 may direct the heater 310 to apply no heat (if no heat is currently being applied), or to maintain the current heat profile. Otherwise, the controller 320 may determine an optimal temperature level to apply to one or more regions of the web 120 based on the tension level, tension type, and/or tension location. An optimal temperature level is the least amount of heat that rectifies the inconsistencies of a region in the web 120 prior to being marked by a printhead. In one embodiment, the controller 320 directs an applied level of heat to an area that is inversely proportional to the measured level of tension in that area. For example, a side of the web 120 with low tension has a relatively high level of heat applied to it, and a side of the web 120 with average or high tension has little or no heat applied.

In one embodiment, the controller 320 manages the rate at which an energy source 550 applies radiant heat to the uneven regions of the web 120 as it travels. In another embodiment, the controller 320 controllably positions the energy source 550 (e.g., vertically and/or laterally) with respect to the web 120 to heat the uneven regions. Alternatively or additionally, the controller 320 manages the heat profile of a heated roller 540 that applies various levels of heat across the width of the web 120 as it passes over the heated roller 540.

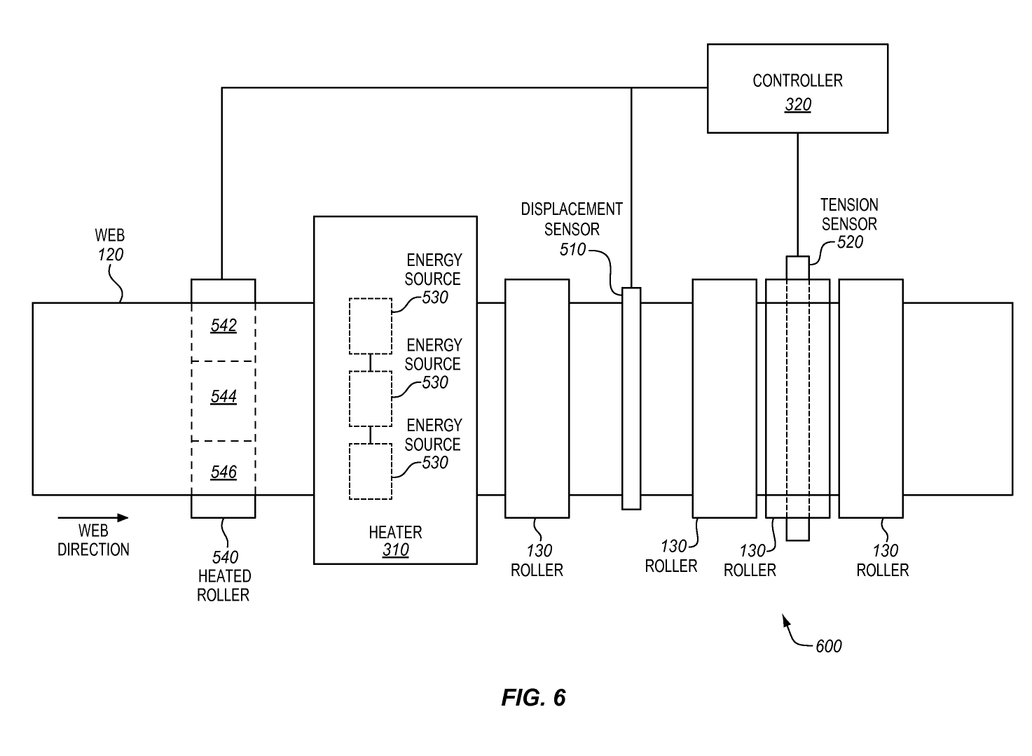

FIG. 6 is a block diagram of a top view of the heat targeting system 500 in another exemplary embodiment. As can be seen in FIG. 6, displacement sensor 510, tension sensor 520, rollers 130, heated roller 540, and energy sources 550 are generally disposed laterally across the entire width of the web 120. However, the components herein are not limited as such. For example, each of the above components may be comprised of one or more segments disposed across a portion of the width of the web 120. Furthermore, each of the components described herein may be disposed vertically above or vertically below the web 120 as a matter of design choice.

The heater 310 and/or heated roller 540 may be comprised of multiple, independently controlled segments. As shown in FIG. 6, energy source 550 is comprised of three segments which each span a portion of the web 120. In one embodiment, each segment of the energy source 550 is independently controlled by the controller 320. Similarly, the heated roller 540 may be comprised of multiple segments (e.g., segments 542-546) that are independently controlled by the controller 320. In this way, the controller 320 may direct targeted heat to regions on the web 120 by managing the rate at which energy is supplied from the appropriate segment(s). This allows the controller 320 to direct an uneven temperature distribution across the width of the web 120. It will be appreciated that the particular arrangement, location and number of energy source 500 segments or heated roller segments 542-546 is matter of design choice and is not limited by the exemplary embodiments of FIGS. 5 and 6.

While specific elements are described with regard to the heat targeting system 500 of FIGS. 5 and 6, the arrangement and type of elements used in FIGS. 5 and 6 may vary as desired in order to heat the web 120 to correct non-uniform physical properties. For example, different numbers, arrangements, and types of each component may be used as desired.

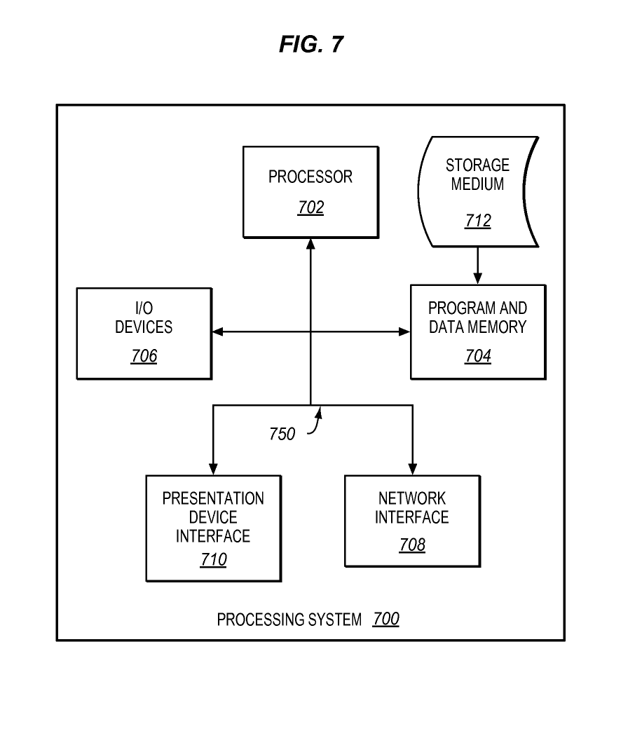

Embodiments disclosed herein can take the form of software, hardware, firmware, or various combinations thereof. In one particular embodiment, software is used to direct a processing system of printing system 300 to perform the various operations disclosed herein. FIG. 7 illustrates a processing system 700 operable to execute a computer readable medium embodying programmed instructions to perform desired functions in an exemplary embodiment. Processing system 700 is operable to perform the above operations by executing programmed instructions tangibly embodied on computer readable storage medium 712. In this regard, embodiments of the invention can take the form of a computer program accessible via computer-readable medium 712 providing program code for use by a computer or any other instruction execution system. For the purposes of this description, computer readable storage medium 712 can be anything that can contain or store the program for use by the computer.

Computer readable storage medium 712 can be an electronic, magnetic, optical, electromagnetic, infrared, or semiconductor device. Examples of computer readable storage medium 712 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

Processing system 700, being suitable for storing and/or executing the program code, includes at least one processor 702 coupled to program and data memory 704 through a system bus 750. Program and data memory 704 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 706 (including but not limited to keyboards, displays, pointing devices, etc.) can be coupled either directly or through intervening I/O controllers. Network adapter interfaces 708 may also be integrated with the system to enable processing system 700 to become coupled to other data processing systems or storage devices through intervening private or public networks. Modems, cable modems, IBM Channel attachments, SCSI, Fibre Channel, and Ethernet cards are just a few of the currently available types of network or host interface adapters. Presentation device interface 710 may be integrated with the system to interface to one or more presentation devices, such as printing systems and displays for presentation of presentation data generated by processor 702.

Although specific embodiments were described herein, the scope of the invention is not limited to those specific embodiments. The scope of the invention is defined by the following claims and any equivalents thereof.

We claim:

1. An apparatus comprising:
a heater configured to apply targeted heat to a web of print media before the web travels through a continuous-forms printer;
a sensor configured to measure a level of tension in at least one region of the web; and
a controller configured to direct the heater to apply a level of heat to the at least one region based on the level of tension.

2. The apparatus of claim 1 wherein:
the controller is configured to maintain a heat profile when the level of tension in the web is even; and
the controller is further configured to adjust the heat profile when the level of tension in the web is uneven.

3. The apparatus of claim 1 wherein:
the level of heat applied to the at least one region is inversely proportional to the level of tension in the at least one region.

4. The system of claim 1 wherein:
the heater comprises an array of radiant infrared lamps.

5. The system of claim 1 wherein:
the heater comprises one or more conductive rollers.

6. The system of claim 1 wherein:
the sensor is configured to measure the level of tension in at least one region of the web based on a vertical displacement in the at least one region.

7. The system of claim 1 wherein:
the sensor is configured to measure the level of tension in at least one region of the web based on a measurement of force in the at least one region.

8. The system of claim 1 wherein:
the sensor is configured to measure the level of tension in the at least one region of the web based at least in part on an edge measurement of the web.

9. A method comprising:
measuring a level of tension in a region of a web of print media for a continuous-forms printer; and
directing a heater to apply a level of heat to the region based on the level of tension before the web travels through the continuous-forms printer.

10. The method of claim 9 further comprising:
maintaining a heat profile when the level of tension in the web is even; and
adjusting the heat profile when the level of tension in the web is uneven.

11. The method of claim 9 wherein:
the level of heat applied to the region is inversely proportional to the measured level of tension in the region.

12. The method of claim 9 wherein:
the heater comprises an array of radiant infrared lamps.

13. The method of claim 9 wherein:
the heater comprises one or more conductive rollers.

14. A non-transitory computer readable medium embodying programmed instructions which, when executed by a processor, are operable to perform a method comprising:
measuring a level of tension in a region of a web of print media for a continuous-forms printer; and
directing a heater to apply a level of heat to the region based on the level of tension before the web travels through the continuous-forms printer.

15. The medium of claim 14 further comprising:
maintaining a heat profile when the level of tension in the web is even; and
adjusting the heat profile when the level of tension in the web is uneven.

16. The medium of claim 14 wherein:
the level of heat applied to the region is inversely proportional to the measured level of tension.

17. The medium of claim 14 wherein:
the heater comprises an array of radiant infrared lamps.

18. The medium of claim 14 wherein:
the heater comprises one or more conductive rollers.
